(19) United States
(12) Patent Application Publication
(10) Pub. No.: US 2006/0255221 A1
(43) Pub. Date: Nov. 16, 2006

(54) Bracket device

(76) Inventor: Chun-Hsien Tseng, Chiayi Hsien (TW)

Correspondence Address: SEYFARTH SHAW LLP, 131 S. DEARBORN ST., SUITE2400, CHICAGO, IL, 60603-5803, US

(21) Appl. No.: 11/130,374

(22) Filed: May 16, 2005

(51) Int. Cl. A47G 29/02; E04G 3/20; E06B 7/28

(52) U.S. Cl. 248/235

(57) ABSTRACT

A bracket device includes opposite lateral walls extending forwardly from a rear mounting wall on an upright surface and respectively having front engaging flanges defining a guide slot therebetween. A supporting member has a rear end portion insertable into an accommodating space defined by the rear mounting wall and lateral walls and in spatial communication with the guide slot, and an engaging piece protruding from opposite surfaces of the rear end portion. When a front end portion of the supporting member is turned downwardly after inserting the rear end portion of the supporting member into the accommodating space, the projections and the rear abutting facet press respectively against the front engaging flanges and the rear mounting wall such that the supporting member is positioned at a selected position.

### BACKGROUND OF THE INVENTION

1. Field of the Invention

The invention relates to a bracket, more particularly to a bracket device adapted to be mounted on a wall surface.

2. Description of the Related Art

FIG. 1 illustrates a conventional bracket 12 suitable for mounting on an uprightly extending wall 10. During assembly, the wall 10 is initially formed with a plurality of bores 101 at selected heights. Subsequently, a plurality of screw fasteners 102 are inserted respectively through a plurality of through holes in the conventional bracket 12, and then respectively threaded in the bores 101. When it is desired to change the height of the conventional bracket 12, it is necessary to form additional bores in the wall 10. Such a process is complicated and time-consuming, and adversely affects the appearance of the wall 10.

FIG. 2 illustrates another conventional bracket device 2 that includes a pair of mounting rails 21 to be mounted on an upright wall (not shown) , two supporting boards 22, each of which is connected to a respective one of the mounting rails 21, and a holder board 23 disposed fixedly on the supporting boards 22. Each mounting rail 21 is formed with a plurality of pairs of screw holes 211. Each supporting board 22 extends into and is fixed to the respective mounting rail 21 by two screws 24 extending through the corresponding screw holes 211 and the supporting board 22. With such a configuration, a screw driver (not shown) is needed during assembly and disassembly. This results in troublesome assembly and disassembly processes.

### SUMMARY OF THE INVENTION

Therefore, the object of the present invention is to provide a bracket device that can eliminate the aforesaid drawbacks of the prior art.

According to the present invention, there is provided a bracket device adapted to be mounted on an upright surface. The bracket device comprises:
a mounting rail extending in a top-to-bottom direction and including a rear mounting wall adapted to be mounted uprightly on and in front of the surface, and opposite lateral walls extending respectively and forwardly from opposite sides of the rear mounting wall, the lateral walls respectively having front ends, and front engaging flanges extending respectively from the front ends toward each other and defining a guide slot between the front engaging flanges, the rear mounting wall cooperating with the lateral walls so as to confine an accommodating space in spatial communication with the guide slot; and
a supporting member including
   a front end portion,
   a rear end portion opposite to the front end portion and insertable into the accommodating space in the mounting rail through the guide slot, the rear end portion having an upright rear abutting facet, and an upper bevel sliding facet extending upwardly and forwardly from an upper end of the rear abutting facet, the rear end portion further having two opposite lateral surfaces, and
   two aligned projections protruding respectively from the opposite lateral surfaces of the rear end portion and proximate to the rear abutting facet and the upper bevel sliding facet of the rear end portion.

The supporting member is operable so as to change between a disengaged state, where the front end portion of the supporting member is turned upwardly so as to enable the upper bevel sliding facet of the rear end portion to contact the rear mounting wall of the mounting rail such that the supporting member is movable along the guide slot in the mounting rail, and an engaged state, where the front end portion of the supporting member is turned downwardly so as to enable the projections and the rear abutting facet of the rear end portion to press respectively against the front engaging flanges and the rear mounting wall of the mounting rail such that the supporting member is positioned at a selected position.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view showing a conventional bracket to be mounted on a wall;

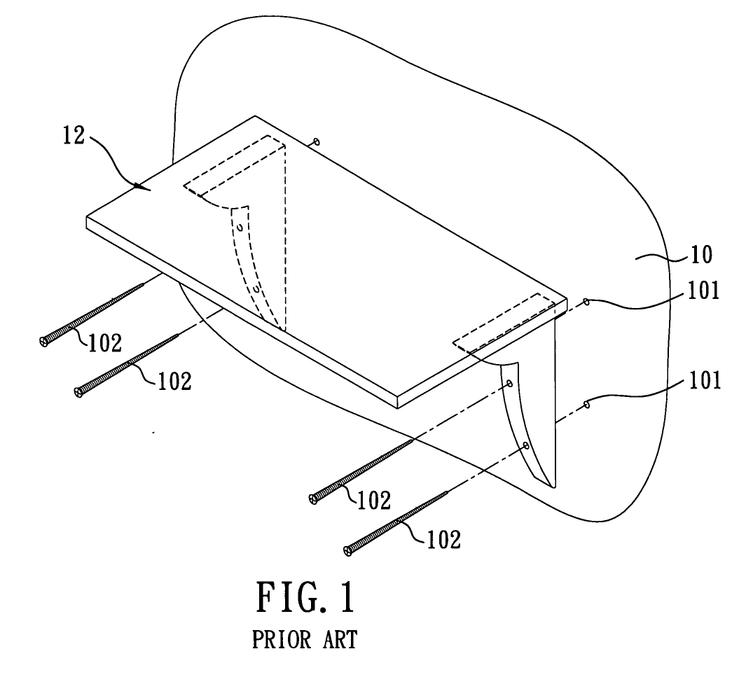

FIG. 2 is an exploded perspective view of another conventional bracket device;

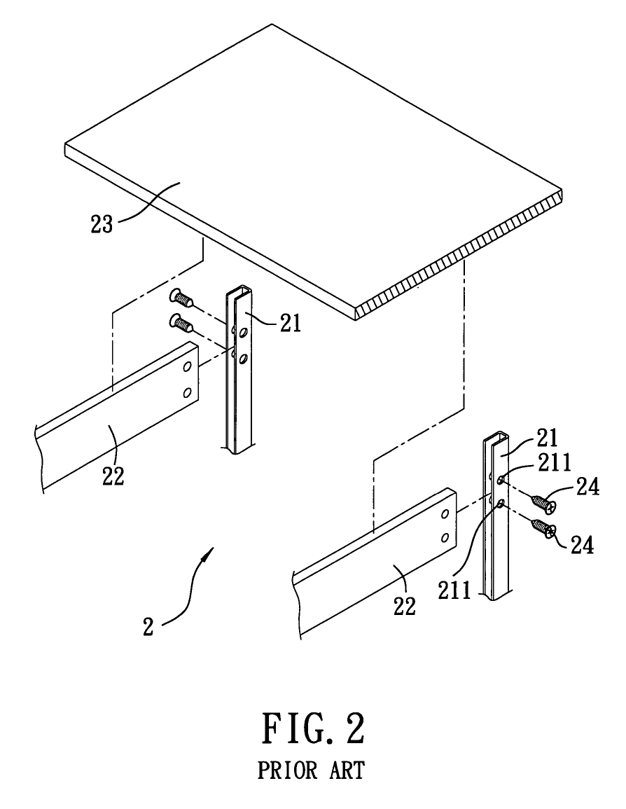

FIG. 3 is an assembled perspective view showing the preferred embodiment of a bracket device according to the present invention;

FIG. 4 is an exploded, partly cutaway perspective view showing the preferred embodiment;

FIG. 5 is an exploded, fragmentary, partly sectional schematic view of the preferred embodiment illustrating how a supporting member is inserted into a mounting rail;

FIG. 6 is a fragmentary, partly sectional schematic view of the preferred embodiment illustrating the supporting member in a disengaged state; and

FIG. 7 is a fragmentary sectional schematic view of the preferred embodiment illustrating the supporting member in an engaged state.

### DETAILED DESCRIPTION OF THE PREFERRED EMBODIMENT

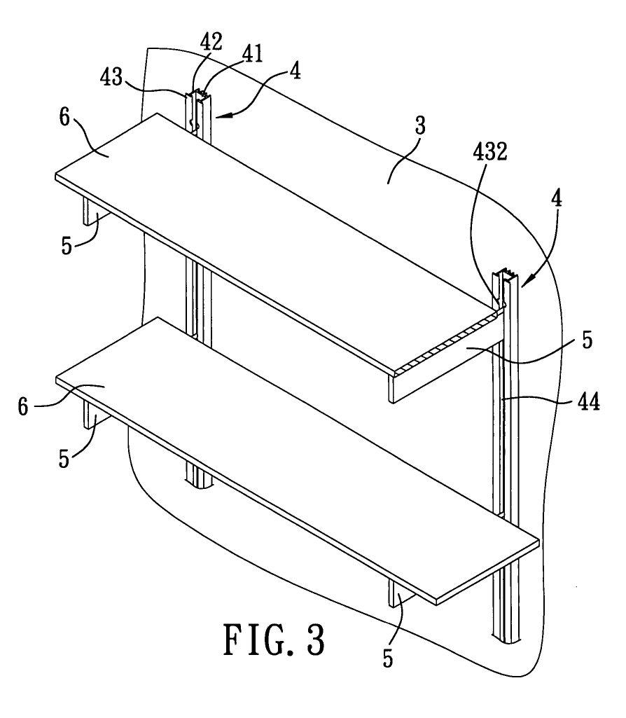

Referring to FIGS. 3 to 5, the preferred embodiment of a bracket device according to the present invention is shown to be adapted to be mounted to an upright surface 3, such as a wall surface, and includes two mounting rails 4, a plurality of supporting members 5, and a plurality of holder boards 6.

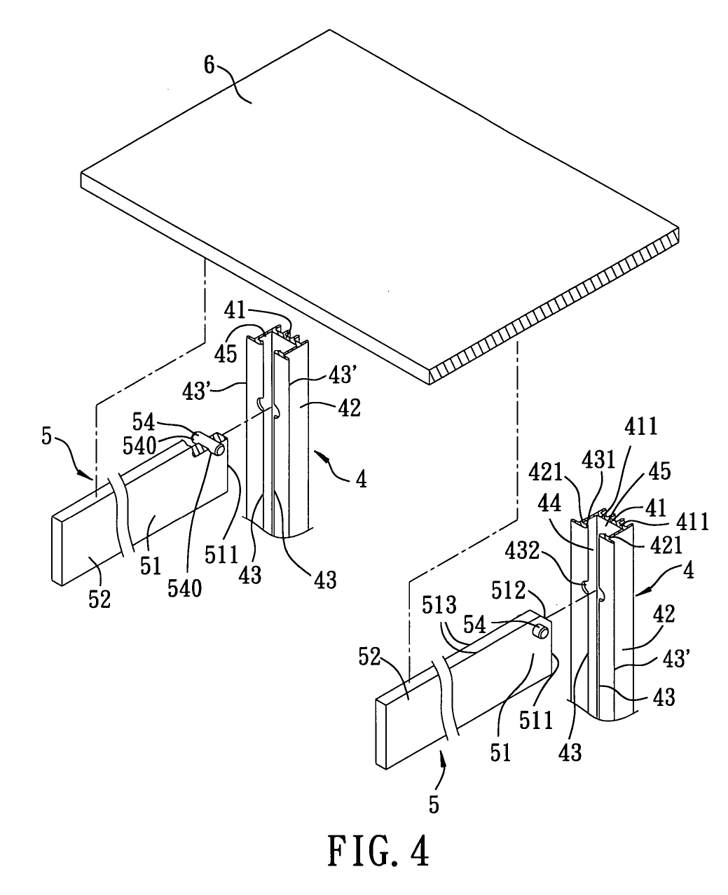

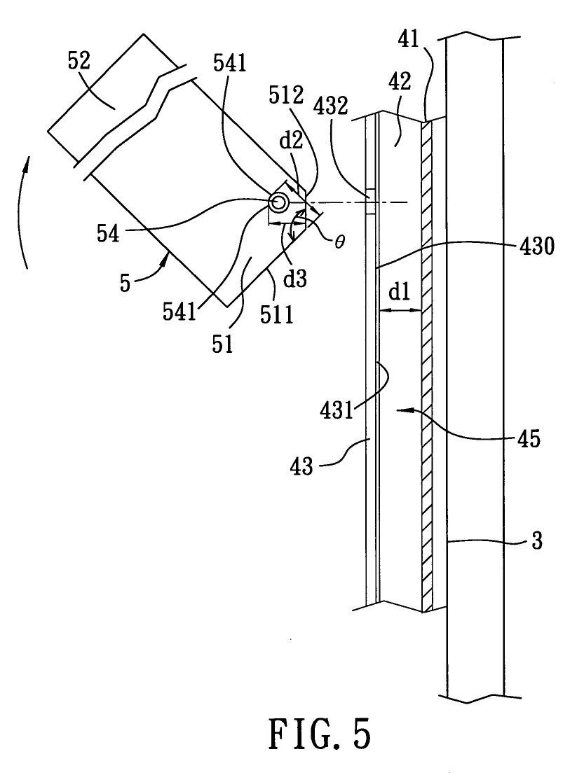

The mounting rails 4 are made of a material of aluminum alloy, are aluminum extrusions in this embodiment, extend in an upward direction, and are spaced apart from each other in a horizontal direction. Each mounting rail 4 includes a rear mounting wall 41 adapted to be mounted uprightly on the surface 3 by means of nails (not shown), and opposite lateral walls 42 extending respectively and forwardly from opposite sides 411 of the rear mounting wall 41. The lateral walls 42 of each mounting rail 4 respectively have front ends 421 extending toward each other, and front engaging flanges 43 extending respectively from the front ends 421 perpendicular to the lateral walls 42 and defining a guide slot 44 between the front engaging flanges 43, as best shown in FIG. 4. Each lateral wall 42 further has a non-engaging flange 43′ extending from the front end 421 in a direction away from the corresponding front engaging flanges 43. For each mounting rail 4, the rear mounting wall 41 cooperates with the lateral walls 42 so as to define an accommodating space 45 in spatial communication with the guide slot 44. In this embodiment, for each mounting rail 4, the front engaging flanges 43 have rear inner surfaces 430, each of which is formed with an uprightly extending rib 431, as shown in FIG. 5. Further, each of the front engaging flanges 43 is formed with a notch 432 which is in spatial communication with the guide slot 44 and which is substantially aligned with that in the other one of the front engaging flanges 43 in the horizontal direction, as best shown in FIG. 4.

Each supporting member 5 is substantially rectangular in this embodiment, and includes a front end portion 52, a rear end portion 51 opposite to the front end portion 52 and insertable into the accommodating space 45 in a respective one of the mounting rails 4, and an engaging piece 54. For each supporting member 5, the rear end portion 51 has an upright rear abutting facet 511, and an upper bevel sliding facet 512 extending upwardly and forwardly from and upper end of the rear abutting facet 511. In this embodiment, an interior angle (θ) between the rear abutting facet 511 and the upper bevel sliding facet 512 is 135°, as shown in FIG. 5. The rear end portion 51 further has two opposite lateral surfaces 513.

For each supporting member 5, the rod-shaped engaging piece 54 penetrates through and is fixed to the rear end portion 51 so as to form two projections 540, which protrude respectively from the opposite lateral surfaces 513 of the rear end portion 51 and which are proximate to the rear abutting facet 511 and the upper bevel sliding facet 512 of the rear end portion 51. The operation of one of the supporting members 5 and the corresponding mounting rail 4 is described in the succeeding paragraphs.

When the rear end portion 51 of the supporting member 5 is inserted into the accommodating space 45 in the corresponding mounting rail 4, the notches 432 in the front engaging flanges 43 of the mounting rail 4 permit extension of the projections 540 therethrough. It is noted that a distance (d1) between the rear mounting wall 41 and the ribs 431 of the mounting rail 4 is slightly smaller than a largest distance (d2) between an outer surface 541 of the engaging piece 54 and the rear abutting facet 511 of the supporting member 5, and is larger than a largest distance (d3) between the outer surface 541 of the engaging piece 54 and the upper bevel sliding facet 512 of the supporting member 5, as shown in FIG. 5.

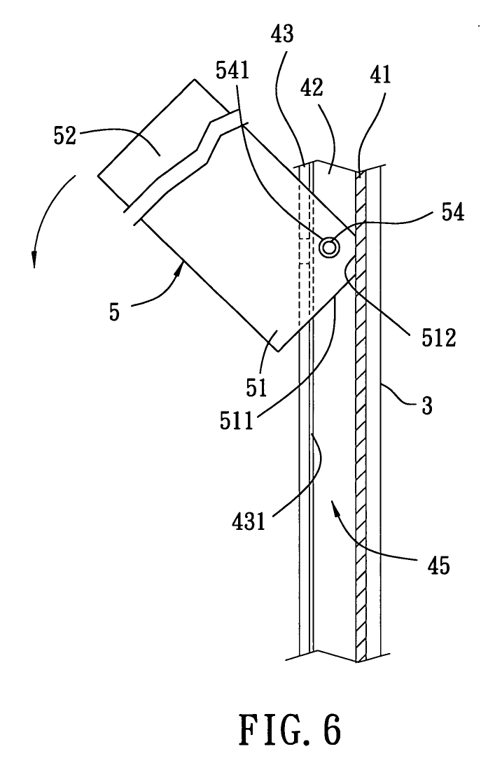

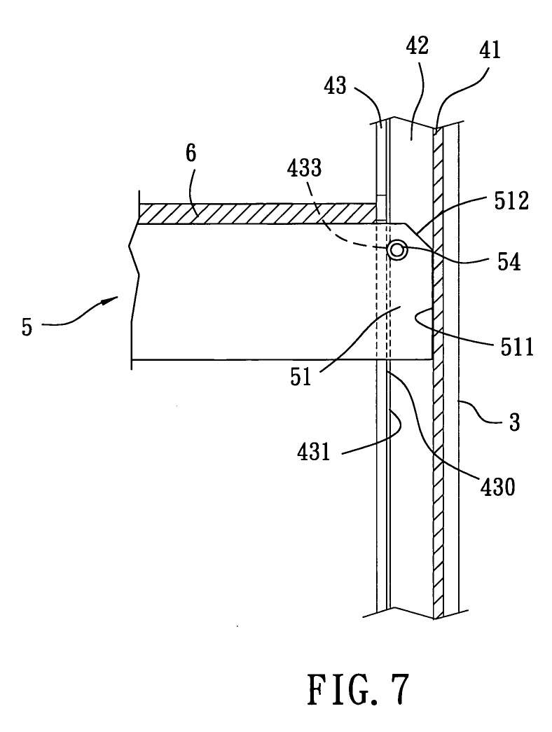

In use, the supporting member 5 is operable so as to change between a disengaged state, where the front end portion 52 is turned upwardly so as to enable the upper bevel sliding facet 512 of the rear end portion 51 to contact the rear mounting wall 41 of the corresponding mounting rail 4 such that the supporting member 4 is movable along the guide slot 44 in the corresponding mounting rail 4, as shown in FIG. 6, and an engaged state, where the front end portion 52 is turned downwardly so as to enable the projections 540 and the rear abutting facet 511 of the rear end portion 51 to press respectively against the ribs 431 of the front engaging flanges 43 and the rear mounting wall 41 of the corresponding mounting rail 4 such that the supporting member 5 is positioned at a selected position, as shown in FIG. 7.

In this embodiment, when the supporting member 5 is operated in the engaged state, the rib 431 of each front engaging flange 43 of the mounting rail 4 is pressed by a respective one of the projections 540 so as to form a notch 433 (see FIG. 7) for engagement therewith.

In this embodiment, with reference to FIG. 3, each holder board 6 bridges two corresponding supporting members 5, which are disposed at the same height, for holding articles or books.

In another embodiment, the holder boards 6 are omitted, and the front end portion of each supporting member 5 can be designed to be hook-shaped for hanging purposes. Alternatively, an elongate article, such as a fishing rod, a billiard cue, a sword or a rifle, can also be disposed over the hook-shaped front end portions 52 of two corresponding supporting members 5, which are disposed at the same height.

In summary, due to the structure of the mounting rails 4 and the supporting members 5 as described above, the bracket device of the present invention can be easily assembled or adjusted without using a tool.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A bracket device adapted to be mounted on an upright surface, comprising:
a mounting rail extending in a top-to-bottom direction and including a rear mounting wall adapted to be mounted uprightly on and in front of the surface, and opposite lateral walls extending respectively and forwardly from opposite sides of said rear mounting wall, said lateral walls respectively having front ends extending toward each other, and front engaging flanges extending respectively from said front ends and defining a guide slot between said front engaging flanges, said rear mounting wall cooperating with said lateral walls so as to confine an accommodating space in spatial communication with said guide slot; and
a supporting member including
a front end portion,
a rear end portion opposite to said front end portion and insertable into said accommodating space in said mounting rail through said guide slot, said rear end portion having an upright rear abutting facet, and an upper bevel sliding facet extending upwardly and forwardly from an upper end of said rear abutting facet, said rear end portion further having two opposite lateral surfaces, and
two aligned projections protruding respectively from said opposite lateral surfaces of said rear end portion and proximate to said rear abutting facet and said upper bevel sliding facet of said rear end portion;
said supporting member being operable so as to change between a disengaged state, where said front end portion of said supporting member is turned upwardly so as to enable said upper bevel sliding facet of said rear end portion to contact said rear mounting wall of said mounting rail such that said supporting member is movable along said guide slot in said mounting rail, and an engaged state, where said front end portion of said supporting member is turned downwardly so as to enable said projections and said rear abutting facet of said rear end portion to press respectively against said front engaging flanges and said rear mounting wall of said mounting rail such that said supporting member is positioned at a selected position.

2. The bracket device as claimed in claim 1, wherein said front engaging flanges of said lateral walls of said mounting rail respectively have rear inner surfaces, each of which is formed with an uprightly extending rib that is pressed by a respective one of said projections of said supporting member so as to form a notch for engagement therewith.

3. The bracket device as claimed in claim 1, wherein each of said front engaging flanges of said lateral walls of said mounting rail is formed with a notch which is in spatial communication with said guide slot, said notches in said front engaging flanges of said lateral walls of said mounting rail permitting extension of said projections therethrough.

4. The bracket device as claimed in claim 1, wherein said mounting rail is made of a material of aluminum alloy.
